(19) United States
(12) Patent Application Publication
(10) Pub. No.: US 2015/0254753 A1
(43) Pub. Date: Sep. 10, 2015

(54) SYSTEM AND METHOD FOR PROPOSING A CONTENT SET FOR PRESENTATION TO A USER

(71) Applicant: DeNA Co., Ltd., Tokyo, (JP)

(72) Inventor: Robert J. Milewski, Tokyo (JP)

(21) Appl. No.: 14/431,746

(22) PCT Filed: Sep. 26, 2012
(86) PCT No.: PCT/JP2012/075589

§ 371 Date: Mar. 26, 2015

(51) Int. Cl. G06Q 30/06; H04L 29/06; G06F 17/30

(52) U.S. Cl. CPC G06Q 30/0631; G06F 17/30336; H04L 67/42

(57) ABSTRACT

One aspect of the present disclosure relates to a system for proposing a content set for presentation to a user. A first content set containing one or more first content items may be provided to a client device for presentation to a user. Whether or not to provide a second content set, which may include different content items from the first content set, may be determined based on degree of lack of interaction of the user with said one or more first content items.

### TECHNICAL FIELD

This disclosure relates to a system and method for proposing a content set for presentation to a user.

### BACKGROUND ART

Some web services implement a recommendation service for providing a recommended set of contents such as music, video or game program contents so that users can easily access contents of their interests. Such services may be used with mobile devices, personal computers, game console, wearable computing and other similar technologies. Typically, conventional content recommendation systems create recommendations based on ratings, purchase histories of contents, browsing histories of contents, game playing histories, etc. Thus, conventional recommendations are generated based on positive feedbacks from users such as explicit feedbacks (e.g., ratings) or implicit feedbacks (e.g., purchase histories). Such contents-recommendation systems may produce reliable recommendations only with a sufficient amount of explicit or implicit feedbacks. On the other hand, in case of a limited amount of positive feedbacks from users, conventional recommendation systems are prone to create recommendations of poor quality.

### SUMMARY OF INVENTION

One aspect of the present disclosure relates to a system for proposing a content set for presentation to a user. A first content set containing one or more first content items may be provided to a client device for presentation to a user. Whether to provide a second content set, which may include different content items from the first content set, may be determined based on degree of lack of interaction of the user with said one or more first content items. Thus, whether to provide a second content set may be determined without relying on any positive user feedbacks such as explicit feedbacks (e.g., rating) or implicit feedbacks (e.g., purchase history). As a result, users may be presented with a second content set without taking any positive actions on the first content set. In other words, a second content set may be recommended to users without requiring the user to use, select, install, download, store, execute or otherwise interact with any one of the content items contained in the first content set.

The system may comprise one or more processors configured to execute computer program modules. In some implementations, the program modules may comprise, along with other things, a communication module, a detection module, an index generation module and/or a determination module.

The communication module may be configured to provide a first content set containing one or more first content items to a client device for presentation to a user. The communication module may also be configured to provide a second content set including one or more second content items to the client device depending on, for example, an index indicative of degree of lack of interaction of the user with one or more of the first content items. In one aspect, one or more of the second content items may be different from any of the first content items. However, in some implementations, some of the second content items may also be contained in the first content set.

The one or more first and/or second content items may include one or more of game programs associated with a game, such as a social game, a video game, an electronic game or an interactive game, game items for use in one or more social games, video games, electronic games, or interactive games, video contents, image contents, or audio contents (e.g., music). The stated one or more first and/or second content items may be streamable or downloadable. It will be appreciated that this is not intended to be limiting, and that the other types of content items may be contained in the first and/or second content set and/or other content sets.

The client device may be configured to facilitate interaction between users thereof and at least one of the first and/or second content items contained in the first and/or second content sets. The client device may be provided with a display or screen for displaying one or more of said first and/or second content items when they are associated with visual contents such as video or image. The client device may display visual representations of game characters, game items or any other game data associated with a game program provided to the client device. Additionally or alternatively, the client device may play music and/or sound when audio contents are provided to the user device.

In some implementations, the client device may be configured to execute various types of game application. The client device may comprise one or more game platforms designed to run game programs associated with the game application. Game items associated with the game application may be provided to the client device together with or separately from the game programs. As used herein, game items may refer to any digital contents that can be used in or associated with one or more games, such as social games, video games, electronic games or interactive games. Examples of such game items may include weapons, protectors, game currencies, electronic cards, and/or game characters.

A user of the client device may interact with one or more of the first and/or second content items by, for example, selecting one or more of the first and/or second content items via any suitable user interface of the client device. In one implementation, upon selection of one or more of the content items, a game application corresponding to the selected content item may be commenced and the user may play an online game or stand alone game associated with the selected game application. Additionally or alternatively, the user may watch video or listen to music each associated with the selected content item(s).

The detection module may be configured to detect lack of interaction of the user with one or more of the first content items provided to the client device for presentation to the user of the client device. In some embodiments, the detection module may be configured to detect one or more of lack of installation, lack of selection, lack of play, or any other user action to the first content items. In some implementations, the detection module may be configured to detect lack of interaction of the user with said one or more first content items based on an elapsed time without receiving any interaction by the user with one or more of the first set of content items. The elapsed time may be counted since the first content set is provided to the client device.

Upon detection of the lack of interaction, the index generation module may generate an index indicative of degree of lack of interaction of the user with one or more of the first content items. The index may be determined to have a greater value in the event that there are less interactions detected between the user and the presented content items. In other words, the decrease in interactions could be represented by an increase in the index value or vice versa; for example, in the situation where the user of a client device is presented content items.

In some implementations, the detection module may be configured to repeatedly detect lack of interaction of the user with one or more of the presented first content items when the user continues to take no actions to the first content items. In the embodiment, the index generation module may include an index counter. The index counter may be configured to generate the index such that the index is incremented upon detection of each of the repeated lack of interaction of the user with the presented content items.

The determination module may be configured to determine whether to provide a second content set including one or more second content items to the client device based on the generated index. In some implementations, the determination module may determine to provide the second content set in response to the index being equal to, or more, than a predetermined threshold. The threshold may be static or dynamic. The threshold may be adaptively updated responsive to user input via the user interface and/or updated automatically based on information input from various sources.

In some implementations, the determination module may be configured to compute an output of a function from the generated index and determine whether to provide the second content set based on the computed output of the function. The function may take any suitable form. In a non-limiting example, the function may be a monotonically decreasing function that may decrease as the index increases, or vice versa.

As noted above, the system may comprise a server device communicatively connected with the client device. In this embodiment, the determination module may determine to provide the second content set in response to the output of the function being equal to or less than a machine epsilon of a computer processor used or associated with the server device.

In some implementations, the server device may be provided with one or more of the communication module, the detection module, the index generation module, the determination module, and/or any other suitable modules.

In some implementations, the client device may be provided with one or more of the communication module, the detection module, the index generation module, the determination module, and/or any other suitable modules.

Detection of lack of interaction of a user with the presented content items may be performed either at the server device or at the client device. In some embodiment, the system may include a client device provided with computer program modules. The computer program modules may comprise a communication module configured to receive a first content set including one or more first content items from a server device; a presentation module configured to present one or more of the first content items to a user; a detection module configured to detect lack of interaction of the user with said one or more first content items; an index generation module configured, upon detection of the lack of interaction, to generate an index indicative of degree of the detected lack of interaction; and a determination module configured to determine whether to provide a second content set including one or more second content items to the client device based on the index, at least one of the second content items being different from any one of the first content items. In some embodiments, the communication module is further configured to send to the server device a request for the second content set based on the determination of the determination module.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF DRAWINGS

FIG. 1 shows a system configured to propose a content set for presentation to a user, in accordance with one or more implementations.

FIG. 2 illustrates an example of a first content set displayed to a user.

FIG. 3 illustrates an example of a second content set displayed to a user.

FIG. 4 illustrates example functions that may be used in one or more implementations.

FIG. 5 illustrates a series of content sets that may be presented to users.

FIG. 6 illustrates an aspect of a method for proposing a content set for presentation to a user, in accordance with one or more implementations.

FIG. 7 illustrates a system configured to propose a content set for presentation to a user, in accordance with one or more implementations.

### DESCRIPTION OF EMBODIMENTS

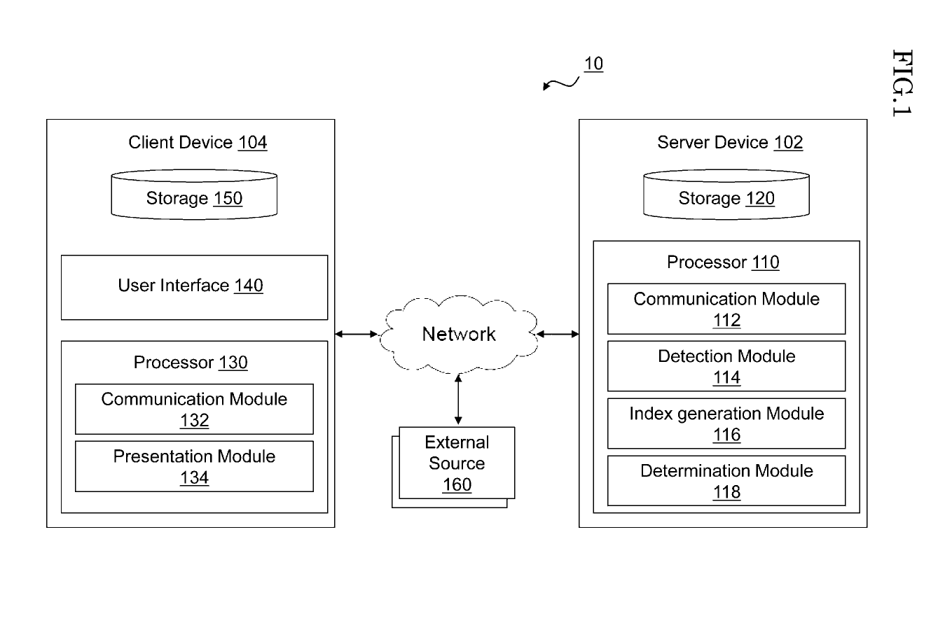

FIG. 1 is a schematic illustration of a system 10 configured to propose a content set for presentation to a user based on detection of lack of interaction of the user with content items presented to the user.

In some embodiments, the system 10 may include a server device 102 and a client device 104. The client device 104 may be communicatively connected with the server device 102 via a network such as the Internet. In some implementations, server device 102, client device 104, and/or external resources 160 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server device 102, client device 104, and/or external resources 160 may be operatively linked via some other communication media.

In some embodiments, the server device 102 may comprise a processor 110 and a storage 120. The storage 120 may be configured to store a variety of content items and other data that may be used by some components in the system 10. At least some of the content items stored in storage 120 may be provided to client device 104.

The client device 104 may comprise a processor 130, user interface 140 and storage 150. The processor 130 may be configured to execute one or more computer program modules. In some implementations, the computer program modules may include one or more of a communication module 132, presentation module 134 and/or other modules.

The communication module 132 may be configured to receive from and transmit to one or more components of system 10 including server device 102 various information associated with a content set. For example, the communication module 132 may receive a content set (or content items contained in a content set) transmitted from the server device 102.

The presentation module 134 may be configured to facilitate presentation of one or more of the content items to users via components of the client device 104. In some implementations, the presentation module 134 may be configured to electronically generate a pictorial image and/or visual representation of each the content items received from server device 102 or other resources. Such an electronically-generated pictorial image and/or visual representation of one or more of content items may be displayed on a monitor or any other display device associated with the client device 104. The presentation module 134 may be configured to cause the display device associated with the client device 104 to present individual ones of a series of electronic images generated from content items.

User interface 140 may be configured to provide an interface between system 10 and one or more users through which the users may provide information to and receive information from system 10. This enables data, cues, results, and/or instructions and any other communicable items, collectively referred to as “information,” to be communicated between a user and processor 130, storage 150, and/or other components of system 10. For example, a user may interact with one or more content items presented to the user via user interface 140 by selecting, executing, downloading, playing and/or taking other actions to content presented to the user. User interface 140 may include any type of interfaces covered by HCI (Human Computer Interaction).

In some implementations, storage 150 may comprise magnetic, electronic, optical and biological storage media that stores information. For example, the storage 150 may electronically store one or more of the content items received from the server device 102.

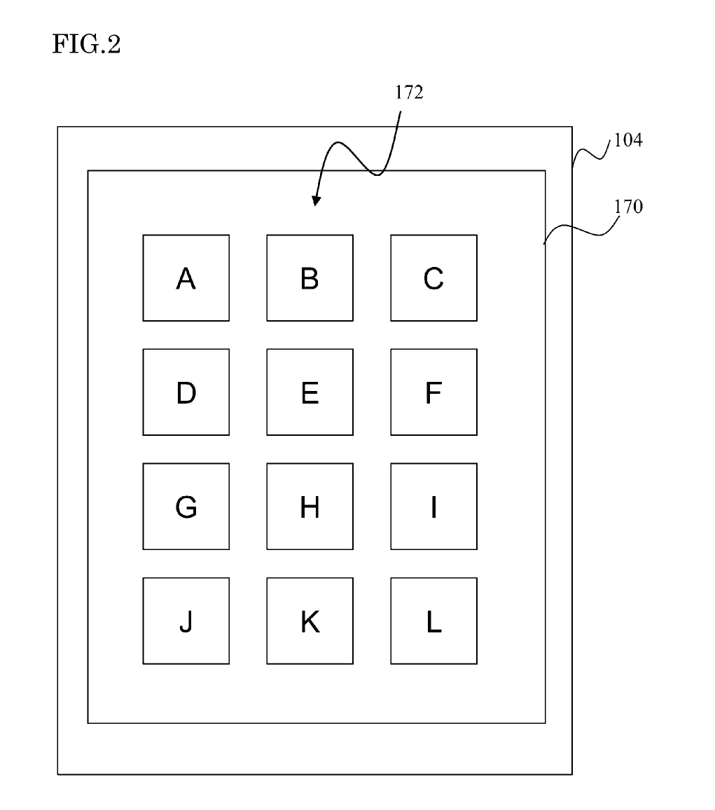

By way of a non-limiting example, FIG. 2 illustrates an example of content items displayed on a client device 104. In the illustrated example shown in FIG. 2, twelve content items 172 are displayed on a touchscreen 170 of client device 104. As shown, the presentation module 134 may cause the touchscreen 170 to display one or more of content items 172. Each of the displayed content items 172 may be associated with various types of contents such as games (e.g., social games, video games, electronic games or interactive games), game items for use in one or more games, video contents, image contents, and/or audio contents.

Users may interact with one or more of the displayed content items 172 by, for example, tapping the touchscreen 170 at one or more locations corresponding to one or more of the displayed content items. In some implementations, a user may tap the touchscreen 170 at a location corresponding to the representation of content item “A” to execute a game application and/or play a video and/or audio content associated with the displayed content item “A.” A user may select any one or more of the displayed or hidden content items. Hidden content items may be displayed on the touchscreen 170 by scrolling the display to the direction towards the bottom.

Returning to FIG. 1, the server device 102 may comprise processor 110 that may be configured to execute one or more computer program modules. The computer program modules may include one or more of a communication module 112, a detection module 114, an index generation module 116, a determination module 118, and/or other modules.

The communication module 112 may be configured to retrieve one or more content items from a storage 120 or other storages to form a content set. As used herein, a content set may refer to a group of content items that may contain one or more content items. In one implementation, a content set may be transmitted to a given client device 104 so that a user thereof may interact with one or more of the content items contained in the content set.

The detection module 114 may be configured to detect lack of interaction of a user of a given client device 104 with one or more content items transmitted from the communication module 112 to the client device 104. As used herein, lack of interaction with content items may refer to lack of installation of one or more of the content items, lack of selection of one or more of the content items, lack of play of one or more of the content items, lack of taking actions to one or more of the content items, and/or any other types of detectable things that might represent lack of interaction of the user with one or more of the content items. For example, the detection module 114 may be configured to detect lack of interaction of the user with one or more content items based on an elapsed time since a content set containing the content items is transmitted to or received by the client device. In some implementations, the detection module 114 may detect lack of interaction if any interaction of the user with at least one of the content items has not been detected during a predetermined period of time.

In some implementations, interaction of a user with one or more of content items may be detected at client device 104 upon user's interaction with (e.g., clicking of) one or more of the content items. For example, an interaction may be detected at client device 104 in response to at least one of the displayed content items (as shown in FIG. 2) being selected, executed, clicked, executed, activated, and/or being interacted in other manners. In response to not detecting such an interaction for a predetermined period of time, the client device 104 (or a computer module thereof) may determine that there is no interaction of the user with one or more of the content items and may generate a signal representing lack of interaction of the user with one or more of the content items. The generated signal may be transmitted to detection module 114 of server device 102 via the network. Upon receipt of the signal representing lack of interaction from the client device 104, the detection module 114 may detect lack of interaction.

The index generation module 116 may be configured to generate an index indicative of degree of lack of interaction of the user with one or more content items upon detection of lack of interaction by the detection module 114. As used herein, the index indicative of degree of lack of interaction of the user with one or more content items may refer to a numerical representation that may represent the degree of lack of interaction. In some implementations, the decrease in interactions could be represented by an increase in the index value or vice versa; for example, in the situation where user of client device 104 is presented content items.

The index may be generated in a variety of manners upon the detection of a lack of interaction of a user of client device 104 when one or more of the content items is presented to the user. For example, the index generation module 116 may be configured to determine the index of a predetermined value upon receipt of a signal representing the lack of interaction that may be generated at, and transmitted, from the client device 104, as noted above. The predetermined value may be 100 frequency units, which is denoted as a point, upon receipt of each signal.

As noted above, the detection module 114 may be configured to repeatedly detect lack of interaction from the user when one or more of the presented first content items receive no actions. In such embodiments, the detection module 114 may receive a plurality of signals representing lack of interaction from the client device 104. The index generation module 116 may comprise an index counter that may be configured, upon receipt of each of the signals, representing lack of interaction, to increment the index. For example, the index generation module 116 may generate an index of 150 points in response to the detection module 114 receiving three signals representing lack of interaction by incrementing the index by 50 points upon receipt of each signal.

In the example embodiment where lack of interaction of a user with one or more content items is detected based on an elapsed time without receiving any interaction by the user, the index may be incremented as the elapsed time becomes longer. In one non-limiting example, the index may be determined to be 50 points in case of 5 seconds of the elapsed time, and 100 points in case of 10 seconds of the elapsed time. The generation of the index is not intended to be limiting as the index may be generated in various other manners.

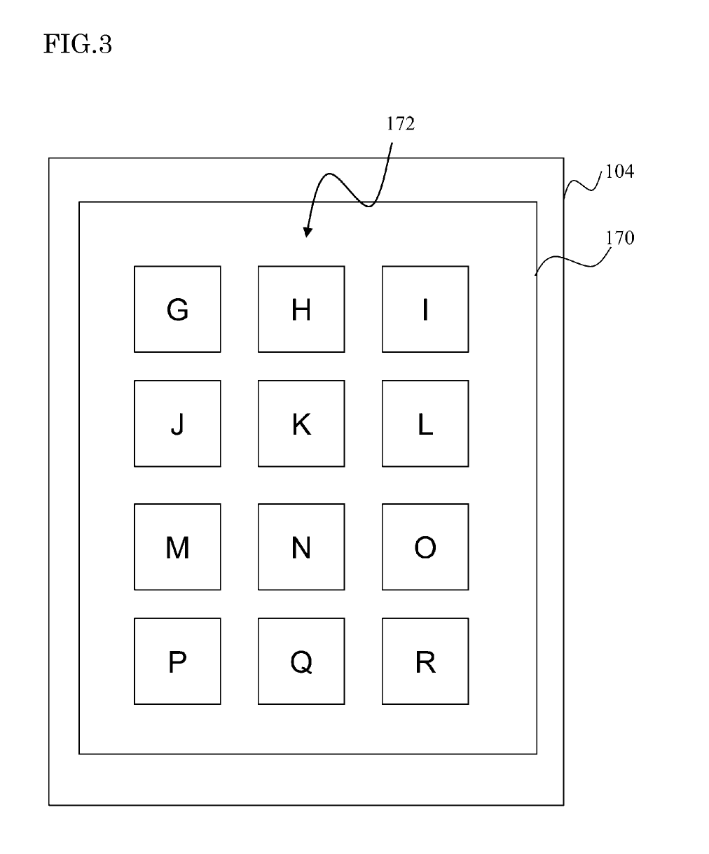

The determination module 118 may be configured to determine whether to provide another content set (as used herein, referred to as the “second content set”) based on the index generated by the index generation module 116. The second content set may contain one or more content items that are different from the content items already presented to the user via client device 104 (as used herein, referred to as the “first content set”). One non-limiting example of the representation of the second content set (or content items contained in the second content set) is shown in FIG. 3. As shown, the second content set may contain twelve content items G-R, among which content items G-L are also contained in the first content set as shown in FIG. 2, whereas content items M-R are not contained in the first content set.

In some implementations, the determination module 118 may determine to present the second content set in response to the generated index being greater than or equal to a predetermined threshold.

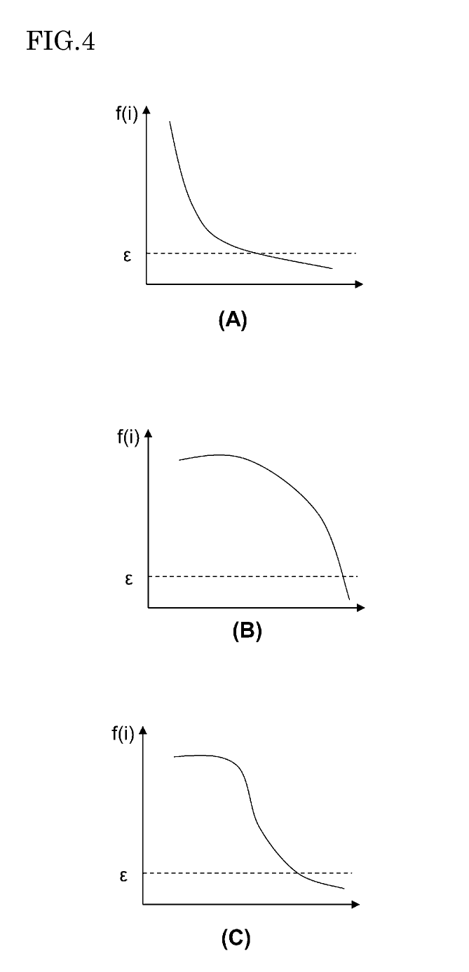

In one implementation, the determination module 118 may be configured to utilize a function to determine whether to provide the second content set. The determination module 118 may be configured to compute an output of the function by taking the index as an input and determine whether to provide the second content set based on the computed output. In some implementations, the determination module may be configured to determine the second content set in response to the output of the function being less than or equal to the machine epsilon of the processor 110. The function may be referred to as an “index function,” as used herein. The index function may refer to any form of continuous function configured so as to decrease as the index increases. Some non-limiting examples of the index function are shown in FIGS. 4(A)-(C). The X-axis of each graph represents a value of the index (“i”), and the Y-axis represents the output of the function (“f(i)”). As shown, the output of the index function may be less than machine epsilon represented “ε” in each of the graph. The index function shown in FIG. 4(A) may allow the output of the function to become less than the machine epsilon more quickly as compared to another index function shown in FIG. 4(B). Accordingly, by utilizing the index function shown in FIG. 4(A), the determination module 118 may determine to provide the second content set more quickly. Thus, the interval for providing the second content set may be adjusted by utilizing different index functions.

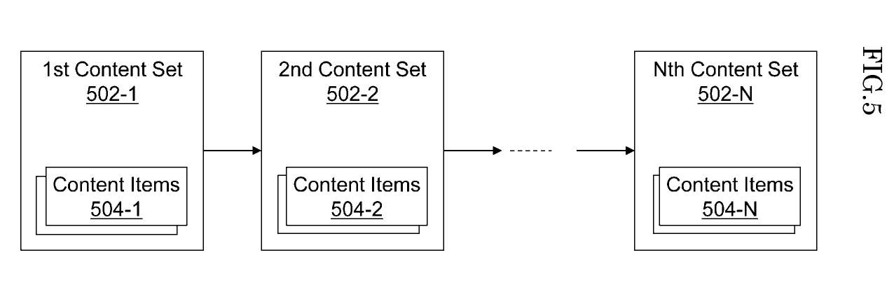

By way of a non-limiting example, FIG. 5 illustrates a series of content sets 502-1 to 502-N each containing one or more content items 504-1 to 504-N associated with corresponding content sets 502-1 to 502-N, respectively. In the example shown in FIG. 5, content sets 502-1 (the first content set) is the first in the sequential order (sequential order indicated by arrows), content sets 502-2 is the second in the sequential order, and content sets 502-N is the Nth (last) content item in the sequential order. When content items 504-1 are displayed on client device 104 as shown in FIG. 2, detection module 114 may detect lack of interaction of a user of the client device 104 with one or more of the content items 504-1 and determination module 118 may determine to provide the second content set 502-2 containing content items 504-2 to the client device based on an index indicative of the degree of lack of interaction. Upon determination by the determination module 118 that the second content set 502-2 is provided to the client device 104, the content items 504-2 contained in the second content set 502-2 are presented to the user (e.g., displayed on the client device 104 as shown in FIG. 3). The above process may be repeated until the Nth content set 502-N is provided to the client device 104.

The storage media of storage 120 and/or 150 may comprise one or both of system storage that is provided integrally (i.e., substantially non-removable) with system 10 and/or removable storage that is interchangeable to system 10 via, for example, a port (e.g., a USB port, a firewire port, etc.) or a drive (e.g., a disk drive, etc.). Storage 120 and/or 150 may comprise one or more optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Storage 120 and/or 150 may store software algorithms, information determined by corresponding processor 110 or 130, and/or other information that enables system 10 to function properly. Storage 120 and/or 150 each may be (in whole or in part) a separate component within system 10, or storage 120 and/or 150 may be provided (in whole or in part) integrally with one or more other components of system 10 (e.g., processors 110 and/or 130, user interface 140, etc.).

Examples of content items contained in the content set may include game programs, game items for use in one or more games (e.g., social games, video games, electronic games or interactive games), video contents, image contents, and/or audio contents. It will be appreciated that those examples of the content items are not intended to be limiting, and rather the present disclosure may apply to any types of content items that can be presented to a user visually, acoustically, tactically, or in any other sensory manner.

The external resources 160 may include sources of information, providers of content items outside of system 10, external entities participating with system 10, and/or other resources. In some implementations, some or all of the functionality attributed herein to external resources 160 may be provided by resources included in system 10.

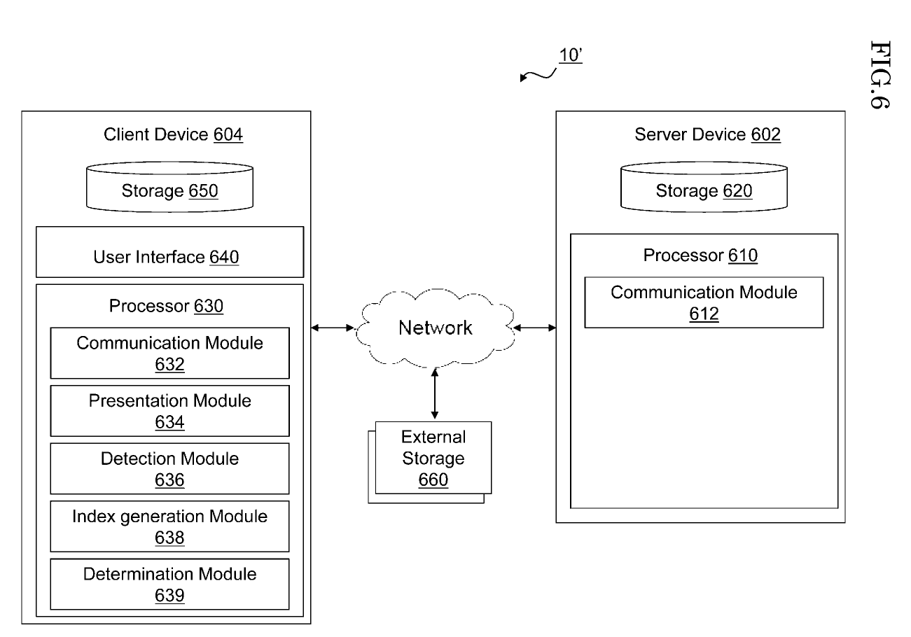

FIG. 6 illustrates a system configured to propose a content set for presentation to a user in accordance with another embodiment where a determination module, a detection module, an index management module, and a determination module are located at client device 604. As shown in FIG. 6, the system 10′ according to the illustrated embodiment may comprise a server device 602 and client device 604. The client device may be communicatively connected with server device 602. Similar to the embodiment shown in FIG. 1, server device 602 may comprise a processor 610 and a storage 620, and client device 604 may comprise a processor 630, a user interface 640 and a storage 650.

In some implementations, the processor 630 may comprise one or more computer modules including a communication module 632, presentation module 634, detection module 636, an index management module 638 and a determination module 639. Similar to the corresponding modules shown in FIG. 1, the communication module 632 may be configured to receive from and transmit to one or more components of system 10 including server device 602 various information associated with a content set, and the presentation module 634 may be configured to facilitate presentation of one or more of the content items to users via components of the client device 604.

The detection module 636, index management module 638 and determination module 639 each may be configured in the same as or similar manner to the corresponding modules in the embodiment shown in FIG. 1. For example, the detection module 636 may be configured to detect lack of interaction of a user of the client device 604 with one or more content items presented to the user. The index management module 638 may be configured to generate an index indicative of degree of lack of interaction of the user with one or more content items presented to the user. The determination module 639 may be configured to determine whether to provide another content set according to the index generated by the index generation module 638.

The communication module 632 may be configured to send to the server device 602 a request for a second content set based on the determination of the determination module 639. Upon receipt of the request for the second content set, the server device 602 may cause the communication module 612 to generate and transmit to the client device 604 the second content set. Thus, the system 10′ may determine whether to provide a second content set based on degree of lack of interaction of a user of client device 604 with one or more of the content items presented to the user.

It should be appreciated that although modules 112, 114, 116, 118, 132 and/or 134 are illustrated in FIG. 1 and modules 612, 632, 634, 636, 638 and 639 are illustrated in FIG. 6 as being co-located within a single processing unit, in implementations in which processor 110, 130, 610, and/or 630 comprise multiple processing units, one or more of modules 112, 114, 116, 118, 132, 134, 612, 632, 634, 636, 638 and 639 may be located remotely from the other modules. The description of the functionality provided by the different modules 112, 114, 116, 118, 132, 134, 612, 632, 634, 636, 638 and 639 described above is for illustrative purposes, and is not intended to be limiting, as any of modules 112, 114, 116, 118, 132, 134, 612, 632, 634, 636, 638 and 639 may provide more or less functionality than is described. For example, one or more of modules 112, 114, 116, 118, 132, 134, 612, 632, 634, 636, 638 and 639 may be eliminated, and some or all of its functionality may be provided by other modules 112, 114, 116, 118, 132,134, 612, 632, 634, 636, 638 and 639. As another example, processor 110, 130, 610 and/or 630 may be configured to execute one or more additional modules that may perform some or all of the functionality attributed to one of modules 112, 114, 116, 118, 132, 134, 612, 632, 634, 636, 638 and 639.

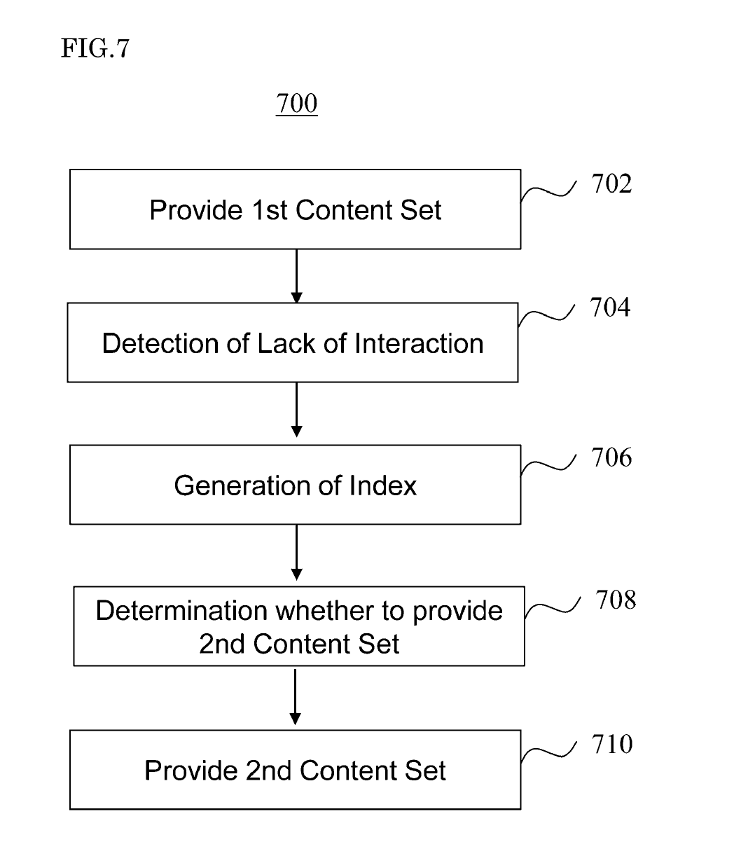

FIG. 7 illustrates a method 700 for proposing a content set to a user of a given client device based on the lack of interaction, from the user, when one or more content items are presented to them. Proposing the content set may be performed with a system comprising a server device and one or more client devices communicatively connected to the server. The content set may be provided from the server to a given client device. The system may comprise one or more sensors. The client device may comprise a processor, a user interface, and storage. The server device may comprise a processor and storage. The processors may be configured to execute computer program modules. The computer program modules at the client device may include a communication module and a presentation module. The computer program modules at the server device may include a communication module, a detection module, an index generation module, and a determination module. The operations of method 700 presented below are intended to be illustrative. In some implementations, method 700 may be accomplished with one or more additional operations not described, and with or without one or more of the operations discussed. Additionally, the order in which the operations of method 700 are illustrated in FIG. 7 and described herein is not intended to be limiting.

In some implementations, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on a storage medium. The one or more processing devices may include one or more devices configured through hardware, firmware, and/or software to be specifically designed for execution of one or more of the operations of method 700.

At an operation 702, first content items contained in a first content set may be presented to a user. In some implementations, operation 702 may be performed by a display provided on client device 104 and a computer program module the same as or similar to presentation module 134 (shown in FIG. 1). The first content set may comprise 12 first content items and the second content items may be displayed on the client device 104 as shown in FIG. 2. The first content set may contain more or less than 12 content items. Some of the first content items may be hidden and not be visible to a user of the client device 104.

At an operation 704, lack of interaction of the user of the client device 104 may be detected. In some implementations, operation 704 may be performed by detection module the same as or similar to detection module 114 (shown in FIG. 1).

At an operation 706, an index indicative of the degree of lack of interaction may be generated. In some implementations, operation 706 may be performed by computer program module the same as or similar to index generation module 116 (shown in FIG. 1).

Operation 708, determines whether or not to provide the client device 104 with a second content set. In some implementations, operation 708 may be performed by a computer program module which is the same as or similar to determination module 118 (shown in FIG. 1 and described herein).

At an operation 710, the second content set (or second content items contained in the second content set) may be transmitted to the client device 104 for presentation to the user thereof. In some implementations, operation 710 may be performed by a computer program module the same as or similar to determination module 118 (shown in FIG. 1). Upon receipt of the second content set containing the second content items, the client device may display one or more of the received content items on the display, as shown in FIG. 2.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. A system for proposing a content set for presentation to a user, the system comprising one or more processors configured to execute computer program modules, the computer program modules comprising:
a communication module configured to provide a first content set including one or more first content items to a client device for presentation to a user, wherein the client device is configured to facilitate interaction between the user and at least one of said one or more first content items;
a detection module configured to detect lack of interaction of the user with said one or more first content items;
an index generation module configured, upon detection of the lack of interaction, to generate an index indicative of degree of the detected lack of interaction; and
a determination module configured to determine whether to provide a second content set including one or more second content items to the client device based on the index, at least one of the second content items being different from any one of the first content items;
wherein the communication module is further configured to provide the second content set to the client device based on the determination of the determination module.

2. The system of claim 1, wherein the detection module is configured to detect one or more of lack of installation of, lack of selection of, lack of play of, or lack of action to one or more of the first content items.

3. The system of claim 1, wherein the detection module is configured to detect lack of interaction of the user with said one or more first content items based on an elapsed time without receiving any interaction from the user with at least one of the first set of content items since the provision of the first content set to the client device.

4. The system of claim 1, wherein the determination module determines to provide the second content set in response to the index being equal to or more than a predetermined threshold.

5. The system of claim 1, wherein the determination module computes an output of a function by taking the index as an input to determine whether to provide the second content set based on the computed output of the function.

6. The system of claim 5, wherein the function is configured so as to decrease as the index increases.

7. The system of claim 6 further comprising a server device communicatively connected with the client device, the server comprising the determination module, wherein the determination module is configured to determine to provide the second content set in response to the output of the function being equal to or less than a machine epsilon of the server device.

8. The system of claim 1, wherein said one or more content items include one or more of game programs, game items for use in one or more games, video contents, image contents, or audio contents.

9. A client device for presenting a content set to a user, the client device comprising one or more processors configured to execute computer program modules, the computer program modules comprising:
a communication module configured to receive a first content set including one or more first content items from a server device;
a presentation module configured to present one or more of the first content items to a user;
a detection module configured to detect lack of interaction of the user with said one or more first content items;
an index generation module configured, upon detection of the lack of interaction, to generate an index indicative of degree of the detected lack of interaction; and
a determination module configured to determine whether to provide a second content set including one or more second content items to the client device based on the index, at least one of the second content items being different from any one of the first content items;
wherein the communication module is further configured to send to the server device a request for the second content set based on the determination of the determination module.

10. The client device of claim 9, wherein the detection module is configured to detect one or more of lack of installation, lack of selection, lack of play of, or lack of activity to one or more of the first content items.

11. The client device of claim 9, wherein the detection module is configured to detect lack of interaction of the user with said one or more first content items based on an elapsed time without receiving any interaction by the user with at least one of the first set of content items since the provision of the first content set to the client device.

12. The client device of claim 9, wherein the determination module determines to send the request in response to the index being equal to or more than a predetermined threshold.

13. The client device of claim 9, wherein the determination module computes an output of a function by taking the index as an input to determine whether to provide the second content set based on the output of the function.

14. The client device of claim 13, wherein the function is configured so as to decrease as the index increases.

15. The client device of claim 14, wherein the determination module determines to send the request in response to the output of the function being equal to or less than a machine epsilon of the client device.

16. The client device of claim 9, wherein said one or more content items include one or more of game programs, game items for use in one or more games, video contents, image contents, or audio contents.

17. A method for proposing a content set for presentation to a user, the method comprising:
providing a first content set including one or more first content items to a client device for presentation to a user, wherein the client device is configured to facilitate interaction between the user and at least one of said one or more first content items;
detecting lack of interaction of the user with said one or more first content items;
generating, upon detection of the lack of interaction, an index indicative of degree of the detected lack of interaction of the user with said one or more first content items; and
determining whether to provide a second content set including one or more second content items to the client device based on the generated index such that at least one of the second content items is different from any one of the first content items;
providing the second content set to the client device based on the determination flow.
